(19) United States
(12) Patent Application Publication
(10) Pub. No.: US 2026/0364457 A1
(43) Pub. Date: Nov. 19, 2026

(54) VIRTUAL WEAPON PROCESSING METHOD AND APPARATUS, COMPUTER DEVICE, AND STORAGE MEDIUM

(71) Applicant: NETEASE (HANGZHOU) NETWORK CO., LTD., Hangzhou, Zhejiang (CN)

(72) Inventors: Xin XU, Hangzhou, Zhejiang (CN); Yinchen LIU, Hangzhou, Zhejiang (CN)

(73) Assignee: NETEASE (HANGZHOU) NETWORK CO., LTD., Hangzhou, Zhejiang (CN)

(21) Appl. No.: 19/145,622

(22) PCT Filed: Jun. 6, 2023
(86) PCT No.: PCT/CN2023/098588

§ 371 Date: Jul. 3, 2025

(30) Foreign Application Priority Data
Jan. 3, 2023 (CN) 202310004864.X

(51) Int. Cl. A63F 13/55; A63F 13/2145; A63F 13/837; G06F 3/041; G06F 3/0486; G06F 3/0488

(52) U.S. Cl. CPC A63F 13/55; A63F 13/2145; A63F 13/837; G06F 3/041; G06F 3/0486; G06F 3/0488; A63F 2300/308; A63F 2300/638; G06F 2203/04105

(57) ABSTRACT

A virtual weapon processing method includes displaying on a graphical user interface an accessory display page of a virtual weapon in response to a first touch control operation for the virtual weapon in a virtual weapon assembly zone displayed on the graphical user interface, where the accessory display page is used for displaying a plurality of candidate virtual weapon accessories capable of being assembled onto the virtual weapon, and the virtual weapon assembly zone is used for displaying the virtual weapon assembled for a first virtual character; and in response to a second touch control operation for the accessory display page, determining a target virtual weapon accessory selected by the second touch control operation from the plurality of candidate virtual weapon accessories, and assembling the target virtual weapon accessory onto the virtual weapon.

### CROSS-REFERENCE TO RELATED APPLICATIONS

The present disclosure claims the priority to the Chinese Patent Application No. 202310004864.X, entitled “VIRTUAL WEAPON PROCESSING METHOD AND APPARATUS, COMPUTER DEVICE, AND STORAGE MEDIUM”, submitted to the Patent Office of the People's Republic of China on Jan. 3, 2023, and the entire contents of which are incorporated into the present disclosure by reference.

### TECHNICAL FIELD

The present disclosure relates to the field of game technologies, and specifically to a virtual weapon processing method and apparatus, a computer device, and a storage medium.

### BACKGROUND

With continuous development of computer communication technologies and widespread popularization and application of terminals such as smartphones, tablet computers and laptop computers, terminals are developing in a direction of diversification and personalization, and are increasingly becoming indispensable terminals for people in their life and work. In order to satisfy people's pursuit for spiritual life, entertainment games that can be operated on terminals have emerged, such as multi-player online action competition games developed based on a client or server architecture. In the action competition game, a player may manipulate a virtual character on a screen to play the game, and may perform, based on a third viewing perspective of the character operated by the player, related operations such as walking, running, jumping, and fighting in a game scene, enabling players to be personally on the scene to experience a visual impact brought about by the game, and greatly enhancing initiative and realism of the game.

At present, in some shooting games, when the player performs combat in a game, the player usually equips game props for the combat. For example, the player may equip the game props such as virtual weapons or virtual explosives for use. Generally, the player may hold a virtual weapon, and another virtual weapon serves as a backup for the player to use through switching when the player performs the combat in the game. Normally, a game prop control corresponding to the two virtual weapons equipped by the player may be fixedly displayed at a bottom of a game interface, and the player may realize a switching operation between the two virtual weapons through a touch control operation to select the virtual weapon that the player wants to use.

### TECHNICAL PROBLEM

In related arts, when the player performs accessory assembly for a virtual weapon, the player often needs to unfold a game backpack interface on a current game image, and find a game accessory suitable for the virtual weapon from many game props displayed on the game backpack interface, which makes steps of accessory assembly for the virtual weapon cumbersome, and affects a speed of the player for performing personalized configuration on the virtual weapon in the game, thus affecting game experience of the player and leading to low efficiency of game interaction.

### TECHNOLOGY SOLUTION

Embodiments of the present disclosure provide a virtual weapon processing method and apparatus, a computer device, and a storage medium, in which a player can perform touch control operations for different virtual weapon assembly regions, thus an accessory display page corresponding to a virtual weapon selected by the user is displayed on a user interface, and virtual weapon accessories capable of being assembled onto the virtual weapon are displayed through the accessory display page, which enables quick completion of accessory equipping and replacement of the virtual weapon, simplifying assembly steps of the virtual weapon accessory of the virtual weapon, improving the efficiency of game interaction, and improving the player's game experience.

In a first aspect, the embodiments of the present disclosure provide a virtual weapon processing method, where a graphical user interface is provided through a terminal, the graphical user interface includes at least a portion of a virtual scene, a first virtual character controlled by the terminal device in the virtual scene, and a virtual weapon assembly zone, where the virtual weapon assembly zone is used for displaying a virtual weapon assembled for the first virtual character; and the method includes:
in response to a first touch control operation for the virtual weapon in the virtual weapon assembly zone, displaying on the graphical user interface an accessory display page of the virtual weapon, where the accessory display page is used for displaying a plurality of candidate virtual weapon accessories capable of being assembled onto the virtual weapon; and
in response to a second touch control operation for the accessory display page, determining a target virtual weapon accessory selected by the second touch control operation from the plurality of candidate virtual weapon accessories, and assembling the target virtual weapon accessory onto the virtual weapon.

In a second aspect, the embodiments of the present disclosure further provide a virtual weapon processing apparatus. The virtual weapon processing apparatus includes:
a first response unit, configured to, in response to a first touch control operation for a virtual weapon in a virtual weapon assembly zone, display on the graphical user interface an accessory display page of the virtual weapon, where the accessory display page is used for displaying a plurality of candidate virtual weapon accessories capable of being assembled onto the virtual weapon; and
a second response unit, configured to, in response to a second touch control operation for the accessory display page, determine a target virtual weapon accessory selected by the second touch control operation from the plurality of candidate virtual weapon accessories, and assemble the target virtual weapon accessory onto the virtual weapon.

In a third aspect, the embodiments of the present disclosure provide a computer device including a processor, a memory and a computer program that is stored in the memory and capable of being run on the processor. The computer program, when executed by the processor, implements steps in any of the virtual weapon processing methods.

In a fourth aspect, the embodiments of the present disclosure provide a computer-readable storage medium, where the computer-readable storage medium stores a computer program. The computer program, when executed by a processor, implements steps in any of the virtual weapon processing methods.

### BENEFICIAL EFFECT

This solution provides a virtual weapon processing method and apparatus, a computer device, and a storage medium, where the accessory display page of the virtual weapon is displayed on the graphical user interface in response to the first touch control operation for the virtual weapon in the virtual weapon assembly zone, and the accessory display page is used for displaying a plurality of candidate virtual weapon accessories capable of being assembled onto the virtual weapon; and in response to the second touch control operation for the accessory display page, the target virtual weapon accessory selected by the second touch control operation from the plurality of candidate virtual weapon accessories is determined, and the target virtual weapon accessory is assembled onto the virtual weapon. The player in the embodiments of the present disclosure can perform touch control operations for different virtual weapon assembly regions, thus the accessory display page corresponding to the virtual weapon selected by the user is displayed on the user interface, and virtual weapon accessories capable of being assembled onto the virtual weapon are displayed through the accessory display page, which enables quick completion of accessory equipping and replacement of the virtual weapon, simplifying assembly steps of the virtual weapon accessory of the virtual weapon, improving the efficiency of game interaction, and improving the player's game experience.

### BRIEF DESCRIPTION OF THE DRAWINGS

In order to more clearly illustrate technical solutions in the embodiments of the present disclosure, accompanying drawings that need to be used in the description of the embodiments will be briefly introduced below. It is apparent that the accompanying drawings in the following description are only some embodiments of the present disclosure, and that for those skilled in the art, other accompanying drawings can be obtained based on these accompanying drawings without making creative labor.

FIG. 1 is a schematic diagram of a scenario of a virtual weapon processing system provided in one embodiment of the present disclosure.

FIG. 2 is a schematic flowchart of a virtual weapon processing method provided in one embodiment of the present disclosure.

FIG. 3 is a schematic diagram of an application scenario of a virtual weapon processing method provided in one embodiment of the present disclosure.

FIG. 4 is a schematic diagram of another application scenario of a virtual weapon processing method provided in one embodiment of the present disclosure.

FIG. 5 is a schematic diagram of another application scenario of a virtual weapon processing method provided in one embodiment of the present disclosure.

FIG. 6 is a schematic diagram of another application scenario of a virtual weapon processing method provided in one embodiment of the present disclosure.

FIG. 7 is a schematic diagram of another application scenario of a virtual weapon processing method provided in one embodiment of the present disclosure.

FIG. 8 is a schematic diagram of another application scenario of a virtual weapon processing method provided in one embodiment of the present disclosure.

FIG. 9 is a schematic diagram of a structure of a virtual weapon processing apparatus provided in one embodiment of the present disclosure.

FIG. 10 is a schematic diagram of a structure of a computer device provided in one embodiment of the present disclosure.

### DETAILED DESCRIPTION OF THIS INVENTION

The technical solutions in the embodiments of the present disclosure will be clearly and completely described below in conjunction with the accompanying drawings in the embodiments of the present disclosure. It is apparent that the described embodiments are only a portion of the embodiments of the present disclosure, but not all of the embodiments. Based on the embodiments in the present disclosure, all other embodiments obtained by those skilled in the art without making creative labor fall within the scope of protection of the present disclosure.

The embodiments of the present disclosure provide a virtual weapon processing method and apparatus, a computer device, and a storage medium. Specifically, the virtual weapon processing method of the embodiments of the present disclosure may be performed by a computer device, where the computer device may be a device such as a terminal or a server. The terminal may be a terminal device such as a smartphone, a tablet computer, a laptop computer, a touch control screen, a game console, a personal computer (PC), a personal digital assistant (PDA), etc. The terminal may also include a client. The client may be a game application client, a browser client carrying a game program, or an instant messaging client, etc. The server may be an independent physical server, a server cluster or a distributed system including a plurality of physical servers, or a cloud server providing basic cloud computing services such as cloud services, cloud databases, cloud computing, cloud functions, cloud storage, network services, cloud communications, middleware services, domain name services, security services, CDNs, and big data and artificial intelligence platforms.

For example, when the virtual weapon processing method is run on a terminal, the terminal device stores a game application program and is configured to present a virtual scene in a game image. The terminal device is configured to interact with the user via a graphical user interface, for example, the game application program is downloaded, installed and run through the terminal device. The terminal device may provide the graphical user interface to the user in a plurality of manners, for example, the graphical user interface may be rendered and displayed on a display screen of the terminal device, or the graphical user interface may be presented through holographic projection. For example, the terminal device may include a touch control display screen and a processor. The touch control display screen is configured to display the graphical user interface and receive an operation instruction generated by the user acting on the graphical user interface. The graphical user interface includes a game image. The processor is configured to run the game, generate the graphical user interface, respond to the operation instruction, and control the displaying of the graphical user interface on the touch control display screen.

For example, when the virtual weapon processing method is run on a server, it may be a cloud game. The cloud game refers to a game manner based on cloud computing. In an operation mode of the cloud game, an operation body of the game application program and a presentation body of the game image are separated. Storage and operation of the virtual weapon processing method are completed on a cloud game server. Presentation of the game image is completed on a cloud game client. The cloud game client is mainly used for receiving and sending game data and the presenting the game image. For example, the cloud game client may be a display device with a data transmission function close to the user side, such as a mobile terminal, a television set, a computer, a PDA, a personal digital assistant, etc., but the terminal device that performs game data processing is the cloud game server at the cloud end. When playing the game, the user operates the cloud game client to send the operation instruction to the cloud game server, and the cloud game server runs the game according to the operation instruction, encodes and compresses data such as the game image, and then returns the data to the cloud game client via a network. Finally, the game image is decoded and output through the cloud game client.

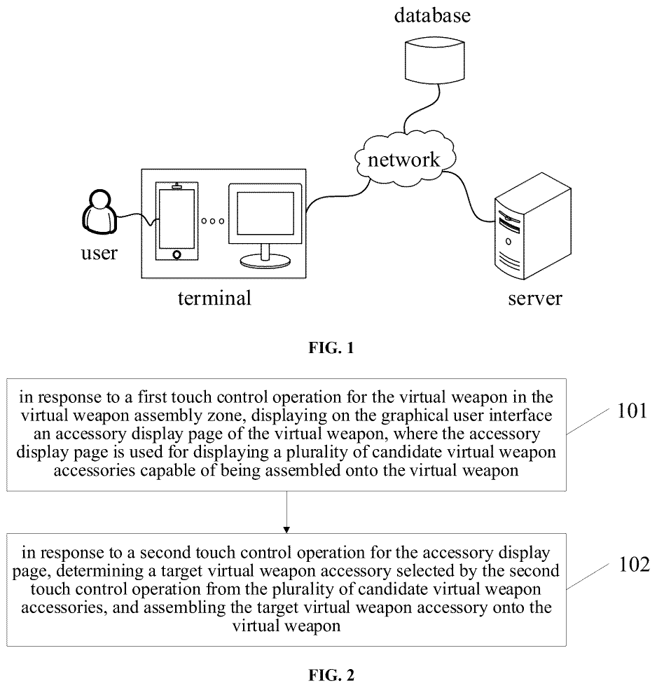

Referring to FIG. 1, FIG. 1 is a schematic diagram of a scenario of a controller system of a game prop provided in an embodiment of the present disclosure. The system may include at least one terminal, at least one server, at least one database, and a network. The terminal held by the user may be connected to servers of different games via the network. The terminal is any device having computing hardware. The computing hardware is capable of supporting and executing a software product corresponding to the game. In addition, when the system includes a plurality of terminals, a plurality of servers, and a plurality of networks, the different terminals may be connected to each other via different networks and via different servers. The network may be a wireless network or a wired network, for example, the wireless network is a wireless local area network (WLAN), a local area network (LAN), a cellular network, a 2G network, a 3G network, a 4G network, a 5G network, etc. In addition, different terminals may use their own Bluetooth networks or hotspot networks to be connected to other terminals or to be connected to the server, etc. For example, a plurality of users may be online through different terminals, and thus connected to each other and synchronized with each other via appropriate networks to support a multi-player game. In addition, the system may include a plurality of databases. The plurality of databases are coupled to different servers. Information related to the game environment may be stored in the databases continuously as different users are online for the multi-player game.

The embodiments of the present disclosure provide a virtual weapon processing method, and the method may be performed by a terminal or a server. The embodiments of the present disclosure are illustrated with an example of the virtual weapon processing method being performed by the terminal. In some embodiments, the terminal may include a touch control display screen and a processor (of course, the terminal may also use a peripheral device such as a mouse and a keyboard as an input device, and the touch control display screen is used as an example only for description herein). The touch control display screen is configured to display a graphical user interface and receive an operation instruction generated by the user acting on the graphical user interface. When the user operates on the graphical user interface through the touch control display screen, the graphical user interface may control local contents of the terminal in response to the received operation instruction, or may control contents of a server at an opposite end in response to the received operation instruction. For example, the operation instruction generated by the user acting on the graphical user interface includes an instruction for launching a game application program, and the processor is configured to launch the game application program after receiving the instruction for launching the game application program provided by the user. In addition, the processor is configured to render and draw on the touch control display screen the graphical user interface associated with the game. The touch control display screen is a multi-touch sensitive screen capable of sensing touch or slide operations performed simultaneously by a plurality of points on the screen. When the user performs touch control operations on the graphical user interface by using a finger, and the graphical user interface, upon detecting the touch control operations, controls different virtual objects on the graphical user interface of the game to perform actions corresponding to the touch control operations. For example, the game may be any one of the games such as a casual game, an action game, a role-playing game, a strategy game, a sports game, and a developmental game. In some embodiments, the game may include a virtual scene of the game drawn on the graphical user interface. Further, the virtual scene of the game may include one or more virtual objects, such as virtual characters, controlled by the user (or player). Additionally, the virtual scene of the game may include one or more obstacles, such as railings, gullies, walls, etc., to restrict movement of the virtual object, such as restricting movement of one or more objects to a particular zone in the virtual scene. Optionally, the virtual scene of the game further includes one or more elements, such as skills, scores, character health status, energy, etc., to provide assistance and virtual services to the player, increase scores related to the player's performance, etc. In addition, the graphical user interface may present one or more indicators to provide indication information to the player. For example, the game may include a virtual object controlled by the player and one or more other virtual objects (such as enemy characters). In an embodiment, one or more other virtual objects are controlled by other players of the game. For example, one or more other virtual objects may be controlled by a computer, such as a robot using artificial intelligence (AI) algorithms to implement a human-machine combat mode. For example, the virtual object possesses various skills or capabilities used by the game player to achieve goals. For example, the virtual object possesses one or more weapons, props, tools, etc. that can be used for eliminating other objects from the game. Such a skill or capability may be activated by the player of the game through using one of a plurality of preset touch control operations with the touch control display screen of the terminal. The processor may be configured to present a corresponding game image in response to the operation instruction generated by the touch control operation of the user.

It should be noted that the schematic diagram of the scenario of the controller system of the game prop shown in FIG. 1 is only an example, and the controller system of the game prop as well as the scenario described in the embodiments of the present disclosure are for the purpose of more clearly illustrating the technical solutions of the embodiments of the present disclosure, and do not constitute a limitation on the technical solutions provided in the embodiments of the present disclosure. Those ordinary skilled in the art can know that, with the emergence of new service scenarios, the technical solutions provided in the embodiments of the present disclosure are equally applicable to similar technical problems.

Based on the above problem, the embodiments of the present disclosure provide a virtual weapon processing method and apparatus, a computer device, and a storage medium, which can save the occupied space of the displayed control on the game interface and improve the display effect of the game image. The following provides detailed description respectively. It should be noted that the order in which the following embodiments are described is not used to limit the preferred order of the embodiments.

The embodiments of the present disclosure provide a virtual weapon processing method. The method may be performed by a terminal or a server. The embodiments of the present disclosure are illustrated by taking the virtual weapon processing method being performed by a terminal as an example. A graphical user interface may be provided through the terminal, the graphical user interface includes at least a portion of a virtual scene, a first virtual character controlled by the terminal device in the virtual scene, and a virtual weapon assembly zone, where the virtual weapon assembly zone is used for displaying a virtual weapon assembled for the first virtual character. The portion of the virtual scene is determined according to a viewing perspective of the first virtual character controlled by the terminal device. The graphical user interface may also display a portion of virtual objects. The portion of the virtual objects is a virtual object displayed in the portion of the virtual scene. The virtual weapon assembled for the first virtual character may be a virtual weapon that the first virtual character is currently using in a handheld manner, or may be a virtual weapon that the first virtual character wears on its body and has not yet used in the handheld manner.

In an embodiment of the present disclosure, the virtual scene is a virtual environment displayed (or provided) when an application program is run on the terminal. The virtual environment may be a simulated environment of the real world, a semi-simulated and semi-fictional three-dimensional environment, or a purely fictional three-dimensional environment. The virtual environment is used for virtual environment combat between at least two virtual characters. The virtual environment is provided with virtual resources available for use by the at least two virtual characters. One or more virtual characters may be displayed in the virtual scene. The virtual character may be the first virtual character, i.e., a master control virtual character controlled by the player through the terminal, a friendly virtual character of the same camp as the first virtual character, an enemy virtual character of a hostile camp to the first virtual character, or an ordinary virtual character of another camp with no hostile relationship to the first virtual character. The first virtual character, the friendly virtual character, and the hostile virtual character may be present in the virtual scene at the same time, and this is an example for illustration, but not a limitation.

The virtual character (or hero) refers to a movable object in the virtual environment. The virtual character refers to a virtual object in the game controlled by the user or the player through the terminal. In an embodiment of the present disclosure, the master control virtual character refers to a virtual object in the game controlled by the current player through the terminal, i.e., a virtual character controlled by the player of this end. The friendly virtual character and the hostile virtual character refer to virtual objects in the game controlled by other players through terminals, i.e., virtual characters controlled by players at other ends.

Referring to FIG. 2, FIG. 2 is a schematic flowchart of a virtual weapon processing method provided in an embodiment of the present disclosure. A specific process of the virtual weapon processing method may be as follows, from step 101 to step 102.

At 101, in response to a first touch control operation for the virtual weapon in the virtual weapon assembly zone, an accessory display page of the virtual weapon is displayed on the graphical user interface, where the accessory display page is used for displaying a plurality of candidate virtual weapon accessories capable of being assembled onto the virtual weapon.

In some embodiments, the virtual weapon may be a virtual firearm, a virtual weaponry, etc. The virtual weapon may cause damage to the virtual character in the virtual scene, and may also increase an attack value for the virtual character equipped with the virtual weapon. The virtual weapon accessory may be an auxiliary accessory equipment and an attack accessory equipment equipped on the virtual weapon in the virtual scene. The virtual weapon accessory may also adjust an attribute value of the virtual character. For example, the virtual weapon accessory includes different types of auxiliary accessory equipment such as scopes, chin rest plates, silencers, wrist guards, etc. The virtual weapon accessory may also include attack accessory equipment such as different types of gun bullets, different types of medicines, etc., where the medicine may be a medicine that increases the attack value for the virtual weaponry. The above equipment may be used for configuring the virtual weapon, enabling the equipment to be in a state of being used in combination with the virtual weapon, thereby increasing the attribute value of the virtual weapon.

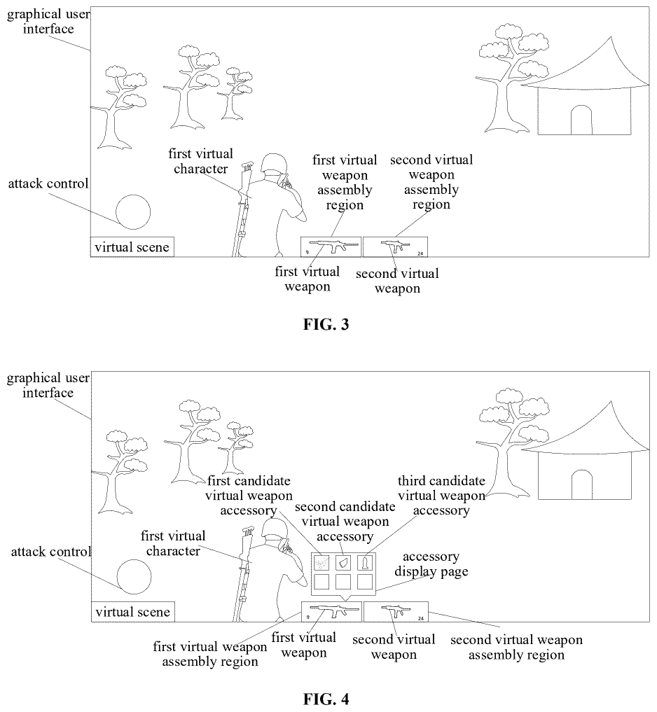

For example, referring to FIG. 3, a graphical user interface is displayed on a touch control display screen of a computer device. A virtual scene, a first virtual character controlled by the terminal device in the virtual scene, and a virtual weapon assembly zone are displayed on the graphical user interface. The virtual weapon assembly zone may include a first virtual weapon assembly region and a second virtual weapon assembly region for displaying a first virtual weapon and a second virtual weapon assembled for the first virtual character, respectively. In this case, the first virtual weapon is assembled in the first virtual weapon assembly region, and the second virtual weapon is assembled in the second virtual weapon assembly region.

Specifically, referring to FIG. 4, the player may trigger a touch control operation on the graphical user interface for the first virtual weapon. The computer device, in response to the first touch control operation for the first virtual weapon in the virtual weapon assembly zone, displays on the graphical user interface an accessory display page of the first virtual weapon, where the accessory display page is used for displaying a plurality of candidate virtual weapon accessories capable of being assembled onto the first virtual weapon. The first virtual weapon may be a virtual firearm. The plurality of candidate virtual weapon accessories that can be displayed on the accessory display page of the first virtual weapon include a first candidate virtual weapon accessory (a scope), a second candidate virtual weapon accessory (a silencer), and a third candidate virtual weapon accessory (a gun bullet).

Optionally, the player may trigger a touch control operation on the graphical user interface for the second virtual weapon. The computer device, in response to the first touch control operation for the second virtual weapon in the virtual weapon assembly zone, displays on the graphical user interface an accessory display page of the second virtual weapon, where the accessory display page is used for displaying a plurality of candidate virtual weapon accessories capable of being assembled onto the second virtual weapon. The second virtual weapon may be a virtual weaponry. The plurality of candidate virtual weapon accessories that can be displayed on the accessory display page of the second virtual weapon include a first candidate virtual weapon accessory (a wrist guard), a second candidate virtual weapon accessory (a first medicine), and a third candidate virtual weapon accessory (a second medicine).

For example, the first touch control operation may be a heavy press operation. The player may trigger, on the graphical user interface, the heavy press operation for the virtual weapon in the virtual weapon assembly zone. The computer device, in response to the heavy press operation for the virtual weapon in the virtual weapon assembly zone, displays on the graphical user interface the accessory display page of the virtual weapon, where the accessory display page is used for displaying a plurality of candidate virtual weapon accessories capable of being assembled onto the virtual weapon.

In an embodiment of the present disclosure, the virtual weapon assembly zone includes a first weapon assembly region and a second weapon assembly region, where the first weapon assembly region is used for displaying a first virtual weapon assembled for the first virtual character, the second weapon assembly region is used for displaying a second virtual weapon assembled for the first virtual character, and the method further includes:
in response to a first switching operation for the first weapon assembly region, controlling the first virtual character to use the first virtual weapon corresponding to the first weapon assembly region; and
in response to a second switching operation for the second weapon assembly region, determining that the first virtual character currently uses a virtual weapon corresponding to the second weapon assembly region, thereby controlling the first virtual character to use the second virtual weapon corresponding to the second weapon assembly region.

In some embodiments, the first switching operation and the second switching operation may be operations such as click operations, slide operations, or double-click operations.

Specifically, the graphical user interface provided by the terminal device in an embodiment of the present disclosure is further provided with a backpack control. The player may unfold a character backpack of the first virtual character by touching and clicking on the backpack control to display a backpack interface of the first virtual character. The backpack interface includes an accessory assembly sub-page and an accessory display sub-page. The player may select a target weapon accessory on the accessory display sub-page, and then assemble the target weapon accessory onto the virtual weapon displayed on the accessory assembly sub-page.

In a specific embodiment, the first touch control operation is an operation satisfying at least one of the following preset conditions:
a contact area between a touch control point of the first touch control operation and the graphical user interface satisfying a preset area threshold;
a pressure value of the first touch control operation satisfying a preset pressure threshold;
the first touch control operation being an operation satisfying a preset touch control duration threshold; and
the first touch control operation being an operation operating on the graphical user interface for a preset number of times within a preset time period.

In order not to occupy a large area of the display image on the graphical user interface, for the step of “in response to the first touch control operation for the virtual weapon in the virtual weapon assembly zone, displaying on the graphical user interface the accessory display page of the virtual weapon”, the method may include:
in response to the first touch control operation for the virtual weapon in the virtual weapon assembly zone, determining a target display position based on a display position of the virtual weapon assembly zone, where the target display position is a position for displaying the accessory display page of the virtual weapon; and
obtaining a preset page size parameter and accessory information, and generating the accessory display page of the virtual weapon based on the preset page size parameter and the accessory information, where the accessory information is accessory information of a virtual weapon accessory, in a prop backpack, capable of being assembled onto the virtual weapon.

For example, a graphical user interface is displayed on a touch control display screen of a computer device. A virtual scene, a first virtual character controlled by the terminal device in the virtual scene, and a virtual weapon assembly zone are displayed on the graphical user interface. The virtual weapon assembly zone may include a first virtual weapon assembly region and a second virtual weapon assembly region for displaying a first virtual weapon and a second virtual weapon assembled for the first virtual character, respectively. In this case, the first virtual weapon is assembled in the first virtual weapon assembly region, and the second virtual weapon is assembled in the second virtual weapon assembly region. The player may trigger a touch control operation on the graphical user interface for the first virtual weapon. The computer device, in response to the first touch control operation for the first virtual weapon in the first virtual weapon assembly region, determines a target display position based on a display position of the first virtual weapon assembly region, and then obtains a preset page size parameter and first accessory information, and generates a first accessory display page of the first virtual weapon based on the preset page size parameter and the first accessory information. The first accessory display page is used for displaying accessory information, such as an accessory identification, of a virtual weapon accessory capable of being assembled onto the first virtual weapon, where the accessory identification includes a first accessory identification, a second accessory identification, and a third accessory identification.

In a specific embodiment, after the step of “in response to the first touch control operation for the virtual weapon in the virtual weapon assembly zone”, and before “displaying on the graphical user interface the accessory display page of the virtual weapon”, the method may include:
determining whether a virtual weapon is assembled in the virtual weapon assembly zone;
if yes, displaying on the graphical user interface the accessory display page of the virtual weapon; and
if no, displaying a weapon selection page on the graphical user interface, where the weapon selection page is used for displaying a virtual weapon, in a prop backpack, capable of being assembled into the virtual weapon assembly zone.

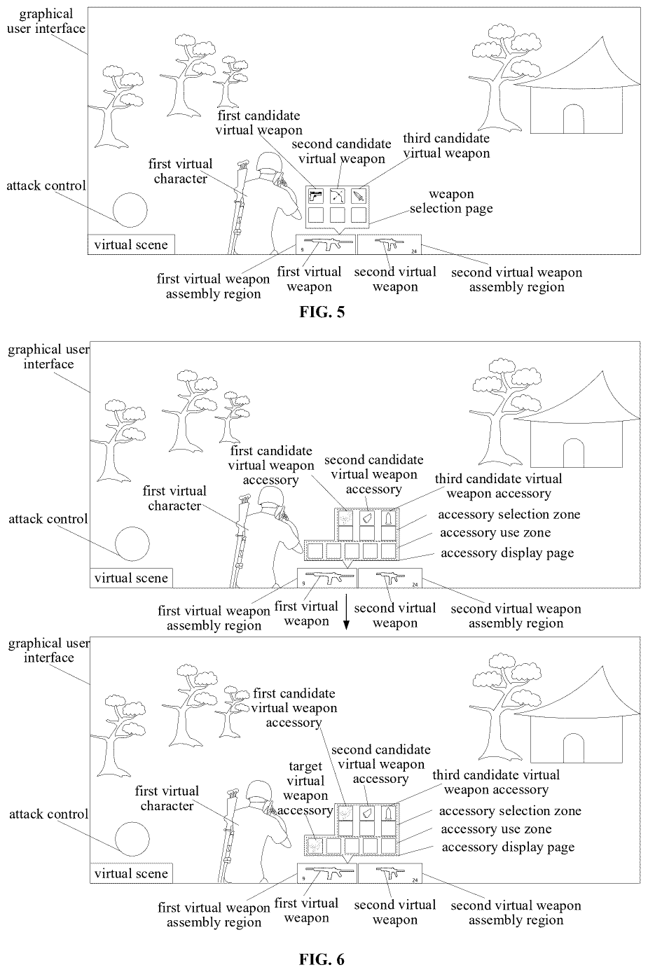

For example, referring to FIG. 5, a graphical user interface is displayed on a touch control display screen of a computer device. A virtual scene, a first virtual character controlled by the terminal device in the virtual scene, and a virtual weapon assembly zone are displayed on the graphical user interface. The virtual weapon assembly zone may include a first virtual weapon assembly region and a second virtual weapon assembly region for displaying a first virtual weapon and a second virtual weapon assembled for the first virtual character, respectively. In this case, the first virtual weapon is assembled in the first virtual weapon assembly region, and a prompt icon is displayed in the second virtual weapon assembly region to indicate that the second virtual weapon assembly region is not equipped with a virtual weapon. The player may trigger a touch control operation on the graphical user interface for the second virtual weapon. The computer device, in response to the first touch control operation for the second virtual weapon assembly region, determines that the second virtual weapon assembly region is not equipped with a virtual weapon. Therefore, a weapon selection page is displayed on the graphical user interface at a side of the second virtual weapon assembly region to display a virtual weapon, in the prop backpack, that is capable of being assembled into the second virtual weapon assembly region, where the virtual weapon may include a first candidate virtual weapon, a third candidate virtual weapon, and a third candidate virtual weapon, all of which are virtual weapons existing in the prop backpack of the first virtual character.

In order to quickly switch pages, for the step of “displaying the weapon selection page on the graphical user interface”, the method may include:
in response to a selection operation for a target virtual weapon on the weapon selection page, assembling the target virtual weapon for the first virtual character, displaying the target virtual weapon in the virtual weapon assembly zone, and generating a page switching instruction for the weapon selection page; and
in response to the page switching instruction for the weapon selection page, canceling the displaying of the weapon selection page on the graphical user interface, and displaying on the graphical user interface the accessory display page of the target virtual weapon.

In order to quickly display a target display page on the graphical user interface, the computer device may determine, according to an operation type of the first touch control operation for the virtual weapon assembly zone, the target display page from a plurality of candidate display pages. Specifically, the first virtual weapon is assembled in the first virtual weapon assembly region. The player may trigger a touch control operation on the graphical user interface for the first virtual weapon. The computer device, in response to the first touch control operation for the first virtual weapon assembly region, displays the accessory display page of the virtual weapon on the graphical user interface if the first touch control operation is a click operation, and displays the weapon selection page on the graphical user interface if the first touch control operation is a double-click operation. In response to the selection operation for the target virtual weapon on the weapon selection page, the computer device replaces the first virtual weapon with the target virtual weapon, cancels the displaying of the weapon selection page on the graphical user interface, and displays on the graphical user interface the accessory display page of the target virtual weapon.

In order to facilitate the user to quickly select a display page, after the step of “in response to the first touch control operation for the virtual weapon in the virtual weapon assembly zone”, and before “displaying on the graphical user interface the accessory display page of the virtual weapon”, the method may include:
in response to the first touch control operation for the virtual weapon in the virtual weapon assembly zone, displaying on the graphical user interface a page selection window, where the page selection window is used for displaying a candidate page identification, and the candidate page identification includes an accessory display page identification and/or a weapon selection page identification; and
in response to a terminate operation of the first touch control operation, determining a candidate page identification corresponding to a terminate position of the operation on the page selection window when the operation is terminated as a target page identification, and displaying on the graphical user interface a display page corresponding to the target page identification.

For example, a graphical user interface is displayed on a touch control display screen of a computer device. A virtual scene, a first virtual character controlled by the terminal device in the virtual scene, and a virtual weapon assembly zone are displayed on the graphical user interface. The virtual weapon assembly zone may include a first virtual weapon assembly region and a second virtual weapon assembly region for displaying a first virtual weapon and a second virtual weapon assembled for the first virtual character, respectively. In this case, the first virtual weapon is assembled in the first virtual weapon assembly region, and the second virtual weapon is assembled in the second virtual weapon assembly region. The player may trigger a touch control operation on the graphical user interface for the first virtual weapon. The computer device, in response to the first touch control operation for the first virtual weapon in the virtual weapon assembly zone, displays on the graphical user interface a page selection window, where a candidate page identification is displayed on the page selection window, and the candidate page identification includes an accessory display page identification and a weapon selection page identification. The player may perform a selection operation on the user interface. The computer device, in response to a terminate operation of the first touch control operation, may determine an accessory display page identification corresponding to a terminate position of the operation on the page selection window when the operation is terminated as a target page identification, and display on the graphical user interface a display page corresponding to the accessory display page identification.

At 102, in response to a second touch control operation for the accessory display page, a target virtual weapon accessory selected by the second touch control operation from the plurality of candidate virtual weapon accessories is determined, and the target virtual weapon accessory is assembled onto the virtual weapon.

In an embodiment of the present disclosure, the player may trigger a click operation for the target virtual weapon accessory in an accessory selection zone. The computer device, in response to the click operation for the target virtual weapon accessory in the accessory selection zone, assembles the target virtual weapon accessory into an accessory use zone. In some embodiments, if a blank slot position is present in the accessory use zone, the target virtual weapon accessory is automatically assembled to the blank slot position. If no blank slot position is present in the accessory use zone, and there are already other weapon accessories in the slot positions, a weapon accessory at a certain slot position is replaced, and thus the target virtual weapon accessory is assembled to this slot position. For example, the first/last weapon accessory in the accessory use zone may be replaced with the target virtual weapon accessory, or a weapon accessory in the accessory use zone that is the same type of accessory as the target virtual weapon accessory may be replaced with the target virtual weapon accessory.

Further, the player may trigger a heavy press operation for the target virtual weapon accessory in the accessory selection zone. The computer device, in response to the heavy press operation for the target virtual weapon accessory in the accessory selection zone, displays an information display zone on the accessory display page displayed on the graphical user interface, and displays accessory information corresponding to the target virtual weapon accessory in the information display zone. In some embodiments, the accessory information may be a detailed description of the target virtual weapon accessory and attribute data for adjusting the virtual weapon to be assembled with the target virtual weapon accessory.

In order to enable the user to conveniently differentiate and view an unassembled accessory and an assembled accessory, the accessory display page includes an accessory selection zone and an accessory use zone, where the accessory selection zone is used for displaying a plurality of candidate virtual weapon accessories capable of being assembled onto the virtual weapon, and the accessory use zone is used for displaying a virtual weapon accessory currently assembled onto the virtual weapon. For the step of “in response to the second touch control operation for the accessory display page, determining the target virtual weapon accessory selected by the second touch control operation from the plurality of virtual weapon accessories, and assembling the target virtual weapon accessory onto the virtual weapon”, the method may include:
in response to the second touch control operation for the accessory selection zone, determining the target virtual weapon accessory selected by the second touch control operation from the plurality of candidate virtual weapon accessories, and assembling the target virtual weapon accessory onto the virtual weapon by adding the target virtual weapon accessory to the accessory use zone.

For example, referring to FIG. 6, the player may trigger a touch control operation for the first virtual weapon on the graphical user interface. The computer device, in response to the first touch control operation for the first virtual weapon in the virtual weapon assembly zone, displays an accessory display page of the first virtual weapon on the graphical user interface, where an accessory selection zone and an accessory use zone are displayed on the accessory display page, and the plurality of candidate virtual weapon accessories that can be displayed in the accessory selection zone include a scope, a silencer, and a gun bullet. In this case, the first virtual weapon is not equipped with accessories, so the slot positions in the accessory use zone are empty. The player may perform, on the graphical user interface, a touch control operation on the first candidate virtual weapon accessory “scope” in the accessory selection zone, and in response to the second touch control operation on the first candidate virtual weapon accessory “scope” in the accessory selection zone, the target virtual weapon accessory selected by the second touch control operation from the plurality of candidate virtual weapon accessories is determined, where the target virtual weapon accessory is the “scope”. The target virtual weapon accessory is added to the accessory use zone, thereby assembling the target virtual weapon accessory onto the virtual weapon.

In a specific embodiment, the method further includes:
in response to a third touch control operation for a virtual weapon accessory to be introduced in the plurality of candidate virtual weapon accessories, displaying an information display zone on the graphical user interface, and displaying in the information display zone accessory information corresponding to the virtual weapon accessory to be introduced, where the third touch control operation is different from the second touch control operation.

In some embodiments, the third touch control operation may be a press operation that satisfies a preset pressure value. The third touch control operation may also be a long press operation that satisfies a preset touch control duration.

In order to display, in the information display zone, accessory information corresponding to a candidate virtual weapon accessory that corresponds to a position where a current touch control point of the second touch control operation is located, the second touch control operation includes a press operation and a lift operation, where the press operation is an operation in which a touch control medium contacts the graphical user interface, and the lift operation is an operation in which the touch control medium is detached from the graphical user interface. The step “in response to the second touch control operation for the accessory display page, determining the target virtual weapon accessory selected by the second touch control operation from the plurality of candidate virtual weapon accessories, and assembling the target virtual weapon accessory onto the virtual weapon” includes:
receiving the press operation for the accessory display page; and
in response to the lift operation, assembling onto the virtual weapon, a virtual weapon accessory, in the plurality of candidate virtual weapon accessories, corresponding to an operation position of the lift operation.

In an embodiment, the method further includes:
in response to a touch control operation parameter of the press operation satisfying a parameter threshold, displaying an information display zone on the accessory display page displayed on the graphical user interface, and displaying in the information display zone accessory information corresponding to the candidate virtual weapon accessory.

For example, when the computer device detects that the player performs a heavy press operation on the graphical user interface, the computer device, in response to the heavy press operation, displays the information display zone on the accessory display page displayed on the graphical user interface, and displays in the information display zone the accessory information corresponding to the candidate virtual weapon accessory. In some embodiments, the parameter threshold satisfied by the touch control operation parameter of the press operation may be a pressure or a touch control duration.

In order to enable the user to conveniently view attribute information of each virtual weapon accessory, the accessory display page further includes an information display zone, and the information display zone is used for displaying accessory information corresponding to the candidate virtual weapon accessory. For the step of “in response to the second touch control operation for the accessory display page”, the method may include:
in response to a third touch control operation for a candidate virtual weapon accessory before the second touch control operation is terminated, displaying in the information display zone accessory information corresponding to the candidate virtual weapon accessory.

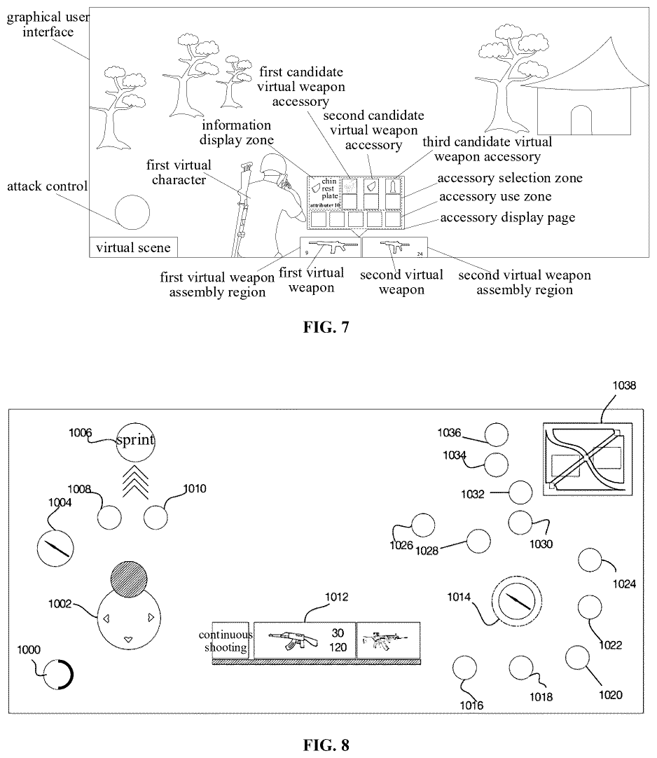

For example, referring to FIG. 7, the player may trigger a touch control operation for the first virtual weapon on the graphical user interface. The computer device, in response to the first touch control operation for the first virtual weapon in the virtual weapon assembly zone, displays on the graphical user interface the accessory display page of the first virtual weapon, where an accessory selection zone and an accessory use zone are displayed on the accessory display page, and the plurality of candidate virtual weapon accessories that can be displayed in the accessory selection zone include a scope, a silencer, and a gun bullet. In this case, the first virtual weapon is not equipped with accessories, so the slot positions in the accessory use zone are empty. The player may perform, on the graphical user interface, a touch control operation on the second candidate virtual weapon accessory “chin rest plate” in the accessory selection zone, and in response to the third touch control operation on the second candidate virtual weapon accessory before the second touch control operation is terminated, the accessory information corresponding to the second candidate virtual weapon accessory is displayed in the information display zone.

In an embodiment, after the step of “in response to the third touch control operation for the candidate virtual weapon accessory before the second touch control operation is terminated, displaying in the information display zone the accessory information corresponding to the candidate virtual weapon accessory”, the method may include:
determining, when detecting that the second touch control operation is terminated, a candidate virtual weapon accessory corresponding to a terminate position where the second touch control operation is located on the accessory display page when the second touch control operation is terminated as the target virtual weapon accessory, and assembling the target virtual weapon accessory onto the virtual weapon.

In another embodiment, the accessory display page further includes an information display zone, the accessory display page further includes an information display zone, the information display zone is used for displaying accessory information and a use control corresponding to the candidate virtual weapon accessory, and the use control is used for assembling a virtual weapon accessory onto the virtual weapon. After the step of “displaying on the graphical user interface the accessory display page of the virtual weapon”, the method may include:
in response to a third touch control operation for a candidate virtual weapon accessory on the accessory display page, displaying, in the information display zone, accessory information and a use control corresponding to the candidate virtual weapon accessory.

In yet another embodiment, for the step of “in response to the second touch control operation for the accessory display page, determining the target virtual weapon accessory selected by the second touch control operation from the plurality of candidate virtual weapon accessories, and assembling the target virtual weapon accessory onto the virtual weapon”, the method may include:
in response to the second touch control operation for a use control in the information display zone on the accessory display page, determining a candidate virtual weapon accessory corresponding to the use control as the target virtual weapon accessory, and assembling the target virtual weapon accessory onto the virtual weapon.

Optionally, for the step of “in response to the second touch control operation for the accessory display page”, the method may include:
in response to a fourth touch control operation for the accessory display page before the second touch control operation is terminated, determining a candidate virtual weapon corresponding to a stop position of the fourth touch control operation on the accessory display page, and displaying an accessory information display window of the candidate virtual weapon accessory, where detailed information of the candidate virtual weapon accessory is displayed on the accessory information display window.

In accordance with the foregoing description, examples will be given below to further illustrate the virtual weapon processing method in the present disclosure. For example, specific embodiments of the virtual weapon processing method are as follows.
(1) A graphical user interface is displayed on a touch control display screen of a computer device. A virtual scene, a first virtual character controlled by the terminal device in the virtual scene, and a virtual weapon assembly zone are displayed on the graphical user interface. The virtual weapon assembly zone may include a first virtual weapon assembly region and a second virtual weapon assembly region for displaying a first virtual weapon and a second virtual weapon assembled for the first virtual character, respectively. In this case, the first virtual weapon is assembled in the first virtual weapon assembly region, and the second virtual weapon is assembled in the second virtual weapon assembly region. The player may trigger a touch control operation on the graphical user interface for the first virtual weapon. The computer device, in response to the first touch control operation for the first virtual weapon in the first virtual weapon assembly region, displays on the graphical user interface an accessory display page of the first virtual weapon, where the accessory display page is used for displaying a plurality of candidate virtual weapon accessories capable of being assembled onto the first virtual weapon. The first virtual weapon may be a virtual firearm. An accessory selection zone and an accessory use zone are displayed on the accessory display page. The plurality of candidate virtual weapon accessories that can be displayed in the accessory selection zone of the first virtual weapon include a first candidate virtual weapon accessory (a scope), a second candidate virtual weapon accessory (a silencer), and a third candidate virtual weapon accessory (a gun bullet). In this case, the first virtual weapon is not equipped with accessories, so the slot positions in the accessory use zone are empty.
(2) The player may perform on the graphical user interface a touch control operation for the first virtual weapon accessory “scope” in the accessory selection zone. In response to the second touch control operation for the virtual weapon accessory “scope” in the accessory selection zone, a target virtual weapon accessory selected by the second touch control operation from the plurality of candidate virtual weapon accessories is determined, where the target virtual weapon accessory is the “scope”, the target virtual weapon accessory is added to the accessory use zone, and thus the target virtual weapon accessory is assembled onto the virtual weapon.

In summary, the embodiments of the present disclosure provide a virtual weapon processing method, where the accessory display page of the virtual weapon is displayed on the graphical user interface in response to the first touch control operation for the virtual weapon in the virtual weapon assembly zone, and the accessory display page is used for displaying a plurality of candidate virtual weapon accessories capable of being assembled onto the virtual weapon; and in response to the second touch control operation for the accessory display page, the target virtual weapon accessory selected by the second touch control operation from the plurality of candidate virtual weapon accessories is determined, and the target virtual weapon accessory is assembled onto the virtual weapon. The player in the embodiments of the present disclosure can perform touch control operations for different virtual weapon assembly regions, thus the accessory display page corresponding to the virtual weapon selected by the user is displayed on the user interface, and virtual weapon accessories capable of being assembled onto the virtual weapon are displayed through the accessory display page, which enables quick completion of accessory equipping and replacement of the virtual weapon, simplifying assembly steps of the virtual weapon accessory of the virtual weapon, improving the efficiency of game interaction, and improving the player's game experience.

In order to facilitate better implementation of the virtual weapon processing method provided in the embodiments of the present disclosure, the embodiments of the present disclosure further provide a virtual weapon display apparatus based on the above-described virtual weapon processing method, the meanings of the terms therein are the same as those in the above-described virtual weapon processing method, and specific implementation details may refer to the description in the method embodiments.

An application scenario of this embodiment is provided below. A schematic diagram of a graphical user interface is as shown in FIG. 8. The interface includes a game scene and a virtual object in the game scene. The game scene and the virtual object are not shown in FIG. 8. A player controls the virtual object to move in the game scene. The interface in FIG. 8 illustrates a variety of controls. The controls are displayed above the game scene.

One of the controls, 1000, is a backpack control, where a touch control operation acting on the control triggers displaying of a backpack interface on the graphical user interface, and the backpack interface is used for viewing of item props of the backpack. The item props may include, but are not limited to, props such as medicines, weapons, accessories, and defenses. In an optional embodiment, an edge of the backpack control is provided with an edge line used for indicating the number of items in the backpack. In some embodiments, the touch control operation acting on the backpack control may be an operation such as a click operation, a double-click operation, a long press operation, a slide operation, etc.

The control 1002 is a movement control, and the circle filled with shadows is a joystick in the movement control. In an optional embodiment, the movement control is configured with a movement response region, where the movement response region may have the same size as the movement control, i.e., the region on the graphical user interface corresponding to the movement control is the movement response region. In an optional embodiment, the size of the movement response region may be larger than the size of the movement control, i.e., the movement control is provided in the movement response region. Specifically, the graphical user interface is divided into left and right regions from the middle, where the left region is the movement response region of the movement control. A movement control instruction is triggered by a touch control operation acting on the movement response region of the movement control, and a movement direction of the virtual object is controlled according to the movement control instruction. In some embodiments, the touch control operation acting on the movement response region of the movement control may be an operation such as a click operation, a double-click operation, a long press operation, a slide operation, etc.

When the touch control operation that triggers the movement control instruction is detected to satisfy a preset condition, the “sprint” instruction is triggered to control the virtual object to run automatically and continuously in the game scene. As shown in FIG. 8, in an optional embodiment, the touch control operation that triggers the movement control instruction satisfying the preset condition is that the touch control operation acting on the joystick region slides in a preset direction to a preset distance or a preset region (e.g., the position indicated by the arrow above the joystick). For example, when the touch control operation drags the joystick upwards, the sprint control 1006 appears, and when the sprint control is triggered, the virtual object enters a fast-running mode. Meanwhile, the control 1030 is also a sprint control, and when the control 1030 is clicked on, the virtual object enters the fast-running mode. In an optional embodiment, the touch control operation that triggers the movement control instruction satisfying the preset condition is that the touch control operation acting on the joystick region satisfies a preset duration, or satisfies a preset pressure, etc.

Both 1004 and 1014 are attack controls. An attack instruction is triggered by a touch control operation acting on an attack response region of the attack control, and the virtual character is controlled, according to the attack instruction, to perform an attack operation in the game scene. In some embodiments, an attack behavior triggered by the attack control corresponds to a current assembly state of the virtual object. For example, when the virtual object is assembled with a long-combat weapon, the attack behavior triggered by the attack control is a shooting behavior, i.e., the left hand may perform a shooting operation by triggering the control 1004, and the right hand may perform a shooting operation by triggering the control 1014. When the virtual character is assembled with a close-combat weapon, the attack behavior triggered by the attack control is a slashing behavior, etc. In an optional embodiment, only one of the attack control 1004 and the attack control 1014 is displayed. In some embodiments, the display position of the attack control may be adjusted according to a position setting instruction, where the position setting instruction may be triggered on a setting interface or may be triggered during the game matchup. In some embodiment, the touch control operation acting on the attack control may be an operation such as a click operation, a double-click operation, a long press operation, a slide operation, etc.

Controls 1008 and 1010 are posture controls. A posture adjustment instruction is triggered by a touch control operation acting on the posture control to adjust a posture of the virtual object in the game scene. In some embodiments, triggering the control 1008 may control the weapon to be located at the left arm position of the virtual object, and control the virtual object to stand in a posture of twisting the head at the left side. Triggering the control 1010 may control the weapon to be located at the right arm position of the virtual object, and control the virtual object to stand in a posture of twisting the head at the right side. The controls 1008 and 1010 are mostly used for controlling the posture of the virtual object when the virtual object is hiding behind an obstacle such as a wall and a tree. In some embodiments, the touch control operation acting on the posture control may be an operation such as a click operation, a double-click operation, a long press operation, a slide operation, etc.

The control 1012 is a weapon slot, that is, the virtual weapon assembly zone described in this solution. Triggering the weapon slot may switch the virtual weapon used by the player. The “continuous shooting” at the left side is used for indicating a current shooting mode. In the “continuous shooting” mode, a plurality of bullets are fired continuously. In addition to the “continuous shooting” mode, a “single shooting’ mode may also be switched to. In the “single shooting” mode, a single bullet is fired. The lower shadow bar is used for showing the number of bullets in the weapon. During shooting, the number of bullets decreases constantly. When the number of bullets reaches zero, automatic replacement of the bullets may be performed, and the number of bullets at this time is at the maximum number. In addition, the control 1016 is a bullet replacement control. Triggering the bullet replacement control may add bullets to the currently used weapon, and after the replacement of the bullets, the number of bullets is at the maximum value. In some embodiments, the touch control operation acting on the weapon slot may be an operation such as a click operation, a double-click operation, a long press operation, a slide operation, etc.

The controls 1018 and 1020 are action controls. The virtual object is controlled, by a touch control operation acting on the action control, to perform a corresponding action in the game scene. For example, triggering the control 1018 may control the virtual object to hunker, and triggering the control 1020 may control the virtual object to adopt a crouch. The control 1022 may control the virtual object to perform a jumping action. In some embodiments, the touch control operation acting on the action control may be an operation such as a click operation, a double-click operation, a long press operation, a slide operation, etc.

The control 1024 is used for controlling a current game scene to enter an open-scope mode. When a first touch control operation acting on the control 1024 is detected, it is controlled to enter the open-scope mode. In the open-scope mode, a sighting lens is displayed in the game scene, and a game scene seen by the virtual object through the sighting lens is also displayed in the game scene. The accuracy of the shooting can be improved in the open-scope mode. When a second touch control operation acting on the control 1024 is detected, it is controlled to exit the open-scope mode. In an optional embodiment, the first touch control operation and the second touch control operation are independent touch control operations. For example, clicking on the control 1024 controls the current game scene to enter the open-scope mode, clicking on the control 1024 again exits the open-scope mode, and a game scene shot by a virtual camera following the virtual object is again displayed. In an optional embodiment, the first touch control operation and the second touch control operation may be a start operation and a terminate operation of one touch control operation. For example, when it is detected that a touch control is performed on the control 1024, the game scene is controlled to enter the open-scope mode, the game scene is controlled to be continuously in the open-scope mode during a continuous press, the game scene is controlled to exit the open-scope mode when it is detected that the touch control that triggers the touch control operation is cut off and leaves the touch control detection region.

The control 1026 is used for controlling a shooting parameter of the virtual camera presenting the game image, thereby adjusting the image of the field of view of the game scene displayed on the graphical user interface. In an optional embodiment, a touch control operation acting on the control 1026 is determined to be detected, and the shooting parameter of the virtual camera is adjusted according to the touch control operation. In some embodiments, the shooting parameter includes, but is not limited to, a position, an orientation, a viewing angle, etc. of the virtual camera. In some embodiments, the touch control operation acting on the control 1026 may be an operation such as a click operation, a double-click operation, a long press operation, a slide operation, etc.

The control 1028 is a marking control. The virtual object, the virtual item, etc. in the game scene are marked through a touch control operation acting on the marking control. The control 1032 is a setting control. Clicking on the control 1032 displays a setting menu. The setting menu is used for setting basic functions of the current game. The touch control operation acting on the control 1028 may be an operation such as a click operation, a double-click operation, a long press operation, a slide operation, etc.

The controls 1034 and 1036 are message controls, where the control 1034 may be used for viewing a system notification, and the control 1036 may be used for viewing a message sent by a teammate or sending a message to a teammate. The control 1038 is a mini-map, is used for displaying a position of the virtual object controlled by the player, and may also be used for displaying a position of a portion of virtual objects of other players.

On the basis of the above application scenarios, the player may apply the first touch control operation to the virtual weapon assembly zone 1012, thereby continuing to perform the virtual weapon processing method in this embodiment.

Referring to FIG. 9, FIG. 9 is a schematic diagram of a structure of a virtual weapon processing apparatus provided in an embodiment of the present disclosure. The apparatus includes:
a first response unit 201, configured to, in response to a first touch control operation for a virtual weapon in a virtual weapon assembly zone, display on the graphical user interface an accessory display page of the virtual weapon, where the accessory display page is used for displaying a plurality of candidate virtual weapon accessories capable of being assembled onto the virtual weapon; and
a second response unit 202, configured to, in response to a second touch control operation for the accessory display page, determine a target virtual weapon accessory selected by the second touch control operation from the plurality of candidate virtual weapon accessories, and assemble the target virtual weapon accessory onto the virtual weapon.

In some embodiments, the virtual weapon processing apparatus includes:
a first response sub-unit, configured to control, in response to a first switching operation for the first weapon assembly region, the first virtual character to use the first virtual weapon corresponding to the first weapon assembly region; and
a second response sub-unit, configured to determine, in response to a second switching operation for the second weapon assembly region, that the first virtual character currently uses a virtual weapon corresponding to the second weapon assembly region, thereby controlling the first virtual character to use the second virtual weapon corresponding to the second weapon assembly region.

In some embodiments, the virtual weapon processing apparatus includes:
a first determining sub-unit, configured to, in response to the second touch control operation for the accessory selection zone, determine the target virtual weapon accessory selected by the second touch control operation from the plurality of candidate virtual weapon accessories, and assemble the target virtual weapon accessory onto the virtual weapon by adding the target virtual weapon accessory to the accessory use zone.

In some embodiments, the virtual weapon processing apparatus includes:
a third response sub-unit, configured to, in response to a third touch control operation for a virtual weapon accessory to be introduced in the plurality of candidate virtual weapon accessories, display an information display zone on the graphical user interface, and display in the information display zone accessory information corresponding to the virtual weapon accessory to be introduced, where the third touch control operation is different from the second touch control operation.

In some embodiments, the virtual weapon processing apparatus includes:
a receiving sub-unit, configured to receive the press operation for the accessory display page; and
a fourth response sub-unit, configured to assemble onto the virtual weapon, in response to the lift operation, a virtual weapon accessory, in the plurality of candidate virtual weapon accessories, corresponding to an operation position of the lift operation.

In some embodiments, the virtual weapon processing apparatus includes:
a fifth response sub-unit, configured to, in response to a touch control operation parameter of the press operation satisfying a parameter threshold, display an information display zone on the accessory display page displayed on the graphical user interface, and display in the information display zone accessory information corresponding to the candidate virtual weapon accessory.

In some embodiments, the virtual weapon processing apparatus includes:
a sixth response sub-unit, configured to display in the information display zone, in response to a third touch control operation for a candidate virtual weapon accessory on the accessory display page, the accessory information and the use control corresponding to the candidate virtual weapon accessory.

In some embodiments, the virtual weapon processing apparatus includes:
a seventh response sub-unit, configured to, in response to the second touch control operation for a use control in the information display zone on the accessory display page, determine a candidate virtual weapon accessory corresponding to the use control as the target virtual weapon accessory, and assemble the target virtual weapon accessory onto the virtual weapon.

In some embodiments, the virtual weapon processing apparatus includes:
an eighth response sub-unit, configured to determine, in response to the first touch control operation for the virtual weapon in the virtual weapon assembly zone, a target display position based on a display position of the virtual weapon assembly zone, where the target display position is a position for displaying the accessory display page of the virtual weapon; and
an obtaining sub-unit, configured to obtain a preset page size parameter and accessory information, and generate the accessory display page of the virtual weapon based on the preset page size parameter and the accessory information, where the accessory information is accessory information of a virtual weapon accessory, in a prop backpack, capable of being assembled onto the virtual weapon.

In some embodiments, the virtual weapon processing apparatus includes:
a second determining sub-unit, configured to determine whether a virtual weapon is assembled in the virtual weapon assembly zone;
a displaying sub-unit, configured to display, if a virtual weapon is assembled in the virtual weapon assembly zone, the accessory display page of the virtual weapon on the graphical user interface; and
a displaying sub-unit, configured to display, if no virtual weapon is assembled in the virtual weapon assembly zone, a weapon selection page on the graphical user interface, where the weapon selection page is used for displaying a virtual weapon, in a prop backpack, capable of being assembled into the virtual weapon assembly zone

In some embodiments, the virtual weapon processing apparatus includes:
a ninth response sub-unit, configured to, in response to a selection operation for a target virtual weapon on the weapon selection page, assemble the target virtual weapon for the first virtual character, display the target virtual weapon in the virtual weapon assembly zone, and generate a page switching instruction for the weapon selection page; and
a ninth response sub-unit, configured to, in response to the page switching instruction for the weapon selection page, cancel the displaying of the weapon selection page on the graphical user interface, and display on the graphical user interface the accessory display page of the target virtual weapon.

In some embodiments, the virtual weapon processing apparatus includes:
a tenth response sub-unit, configured to display, in response to the first touch control operation for the virtual weapon in the virtual weapon assembly zone, on the graphical user interface a page selection window, where the page selection window is used for displaying a candidate page identification, and the candidate page identification includes an accessory display page identification and/or a weapon selection page identification; and
a tenth response sub-unit, configured to, in response to a terminate operation of the first touch control operation, determine a candidate page identification corresponding to a terminate position of the operation on the page selection window when the operation is terminated as a target page identification, and display on the graphical user interface a display page corresponding to the target page identification.

The embodiments of the present disclosure provide a virtual weapon processing apparatus, where the first response unit 201 displays, in response to the first touch control operation for the virtual weapon in the virtual weapon assembly zone, the accessory display page of the virtual weapon on the graphical user interface, and the accessory display page is used for displaying a plurality of candidate virtual weapon accessories capable of being assembled onto the virtual weapon; and the second response unit 202, in response to the second touch control operation for the accessory display page, determines the target virtual weapon accessory selected by the second touch control operation from the plurality of candidate virtual weapon accessories, and assembles the target virtual weapon accessory onto the virtual weapon. The player in the embodiments of the present disclosure can perform touch control operations for different virtual weapon assembly regions, thus the accessory display page corresponding to the virtual weapon selected by the user is displayed on the user interface, and virtual weapon accessories capable of being assembled onto the virtual weapon are displayed through the accessory display page, which enables quick completion of accessory equipping and replacement of the virtual weapon, simplifying assembly steps of the virtual weapon accessory of the virtual weapon, improving the efficiency of game interaction, and improving the player's game experience.

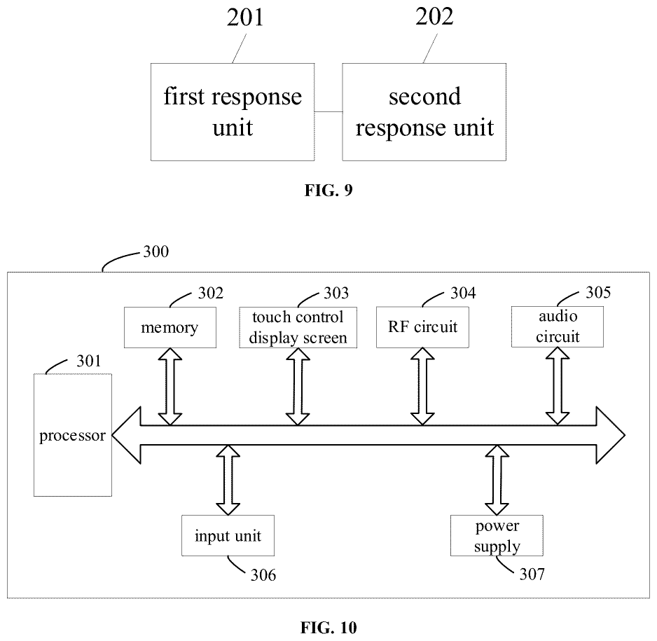

Correspondingly, the embodiments of the present disclosure further provide a computer device. The computer device may be a terminal or a server. The terminal may be a terminal device such as a smartphone, a tablet computer, a laptop computer, a touch control screen, a game console, a PC, a PDA, etc. As shown in FIG. 10, FIG. 10 is a schematic diagram of a structure of a computer device provided in an embodiment of the present disclosure. The computer device 300 includes a processor 301 having one or more processing cores, a memory 302 having one or more computer-readable storage media, and a computer program stored in the memory 302 and capable of being run on the processor. In this embodiment, the processor 301 is electrically connected to the memory 302. Those skilled in the art can understand that the structure of the computer device illustrated in the drawing does not constitute a limitation on the computer device, and the computer device may include more or fewer components than those illustrated in the drawing, or a combination of certain components, or a different arrangement of components.

The processor 301 is the control center of the computer device 300, connects the portions of the entire computer device 300 by using various interfaces and lines, and performs various functions of the computer device 300 and processes data by running or loading software programs and/or modules stored in the memory 302, and by invoking data stored in the memory 302, thereby performing overall monitoring on the computer device 300.

In an embodiment of the present disclosure, the processor 301 in the computer device 300, in accordance with the following steps, may load instructions corresponding to processes of one or more application programs into the memory 302, and run the application programs stored in the memory 302, thereby implementing various functions:
in response to a first touch control operation for the virtual weapon in the virtual weapon assembly zone, displaying on the graphical user interface an accessory display page of the virtual weapon, where the accessory display page is used for displaying a plurality of candidate virtual weapon accessories capable of being assembled onto the virtual weapon; and
in response to a second touch control operation for the accessory display page, determining a target virtual weapon accessory selected by the second touch control operation from the plurality of candidate virtual weapon accessories, and assembling the target virtual weapon accessory onto the virtual weapon.

In an embodiment, the virtual weapon assembly zone includes a first weapon assembly region and a second weapon assembly region, the first weapon assembly region is used for displaying a first virtual weapon assembled for the first virtual character, and the second weapon assembly region is used for displaying a second virtual weapon assembled for the first virtual character; and
the method includes:
in response to a first switching operation for the first weapon assembly region, controlling the first virtual character to use the first virtual weapon corresponding to the first weapon assembly region; and
in response to a second switching operation for the second weapon assembly region, determining that the first virtual character currently uses a virtual weapon corresponding to the second weapon assembly region, thereby controlling the first virtual character to use the second virtual weapon corresponding to the second weapon assembly region.

In an embodiment, the first touch control operation is an operation satisfying at least one of the following preset conditions:
a contact area between a touch control point of the first touch control operation and the graphical user interface satisfying a preset area threshold;
a pressure value of the first touch control operation satisfying a preset pressure threshold;
the first touch control operation being an operation satisfying a preset touch control duration threshold; and
the first touch control operation being an operation operating on the graphical user interface for a preset number of times within a preset time period.

In an embodiment, the accessory display page includes an accessory selection zone and an accessory use zone, where the accessory selection zone is used for displaying the plurality of candidate virtual weapon accessories capable of being assembled onto the virtual weapon, and the accessory use zone is used for displaying a virtual weapon accessory currently assembled onto the virtual weapon; and
in response to the second touch control operation for the accessory display page, determining the target virtual weapon accessory selected by the second touch control operation from the plurality of virtual weapon accessories, and assembling the target virtual weapon accessory onto the virtual weapon includes:
in response to the second touch control operation for the accessory selection zone, determining the target virtual weapon accessory selected by the second touch control operation from the plurality of candidate virtual weapon accessories, and assembling the target virtual weapon accessory onto the virtual weapon by adding the target virtual weapon accessory to the accessory use zone.

In an embodiment, the method further includes:
in response to a third touch control operation for a virtual weapon accessory to be introduced in the plurality of candidate virtual weapon accessories, displaying an information display zone on the graphical user interface, and displaying in the information display zone accessory information corresponding to the virtual weapon accessory to be introduced, where the third touch control operation is different from the second touch control operation.

In an embodiment, the second touch control operation includes a press operation and a lift operation, where the press operation is an operation in which a touch control medium contacts the graphical user interface, and the lift operation is an operation in which the touch control medium is detached from the graphical user interface;
the step of in response to the second touch control operation for the accessory display page, determining the target virtual weapon accessory selected by the second touch control operation from the plurality of candidate virtual weapon accessories, and assembling the target virtual weapon accessory onto the virtual weapon includes:
receiving the press operation for the accessory display page; and
in response to the lift operation, assembling onto the virtual weapon, a virtual weapon accessory, in the plurality of candidate virtual weapon accessories, corresponding to an operation position of the lift operation.

In an embodiment, the method further includes:
in response to a touch control operation parameter of the press operation satisfying a parameter threshold, displaying an information display zone on the accessory display page displayed on the graphical user interface, and displaying in the information display zone accessory information corresponding to the candidate virtual weapon accessory.

In an embodiment, the accessory display page further includes an information display zone, the information display zone is used for displaying accessory information and a use control corresponding to the candidate virtual weapon accessory, and the use control is used for assembling a virtual weapon accessory onto the virtual weapon;
after displaying on the graphical user interface the accessory display page of the virtual weapon, the method further includes:
in response to a third touch control operation for a candidate virtual weapon accessory on the accessory display page, displaying, in the information display zone, accessory information and a use control corresponding to the candidate virtual weapon accessory.

In an embodiment, in response to the second touch control operation for the accessory display page, determining the target virtual weapon accessory selected by the second touch control operation from the plurality of candidate virtual weapon accessories, and assembling the target virtual weapon accessory onto the virtual weapon includes:
in response to the second touch control operation for a use control in the information display zone on the accessory display page, determining a candidate virtual weapon accessory corresponding to the use control as the target virtual weapon accessory, and assembling the target virtual weapon accessory onto the virtual weapon.

In an embodiment, in response to the first touch control operation for the virtual weapon in the virtual weapon assembly zone, displaying on the graphical user interface the accessory display page of the virtual weapon includes:
in response to the first touch control operation for the virtual weapon in the virtual weapon assembly zone, determining a target display position based on a display position of the virtual weapon assembly zone, where the target display position is a position for displaying the accessory display page of the virtual weapon; and
obtaining a preset page size parameter and accessory information, and generating the accessory display page of the virtual weapon based on the preset page size parameter and the accessory information, where the accessory information is accessory information of a virtual weapon accessory, in a prop backpack, capable of being assembled onto the virtual weapon.

In an embodiment, after in response to the first touch control operation for the virtual weapon in the virtual weapon assembly zone, and before displaying on the graphical user interface the accessory display page of the virtual weapon, the method further includes:
determining whether a virtual weapon is assembled in the virtual weapon assembly zone;
if yes, displaying on the graphical user interface the accessory display page of the virtual weapon; and
if no, displaying a weapon selection page on the graphical user interface, where the weapon selection page is used for displaying a virtual weapon, in a prop backpack, capable of being assembled into the virtual weapon assembly zone.

In an embodiment, displaying the weapon selection page on the graphical user interface includes:
in response to a selection operation for a target virtual weapon on the weapon selection page, assembling the target virtual weapon for the first virtual character, displaying the target virtual weapon in the virtual weapon assembly zone, and generating a page switching instruction for the weapon selection page; and
in response to the page switching instruction for the weapon selection page, canceling the displaying of the weapon selection page on the graphical user interface, and displaying on the graphical user interface the accessory display page of the target virtual weapon.

In an embodiment, after in response to the first touch control operation for the virtual weapon in the virtual weapon assembly zone, and before displaying on the graphical user interface the accessory display page of the virtual weapon, the method further includes:
in response to the first touch control operation for the virtual weapon in the virtual weapon assembly zone, displaying on the graphical user interface a page selection window, where the page selection window is used for displaying a candidate page identification, and the candidate page identification includes an accessory display page identification and/or a weapon selection page identification; and
in response to a terminate operation of the first touch control operation, determining a candidate page identification corresponding to a terminate position of the operation on the page selection window when the operation is terminated as a target page identification, and displaying on the graphical user interface a display page corresponding to the target page identification.

The specific embodiments of the above operations may refer to the foregoing embodiments, and will not be repeated here.

Optionally, as shown in FIG. 10, the computer device 300 further includes a touch control display screen 303, a radio frequency (RF) circuit 304, an audio circuit 305, an input unit 306, and a power supply 307. In this embodiment, the processor 301 is electrically connected to the touch control display screen 303, the RF circuit 304, the audio circuit 305, the input unit 306, and the power supply 307, respectively. Those skilled in the art can understand that the structure of the computer device illustrated in FIG. 10 does not constitute a limitation on the computer device, and the computer device may include more or fewer components than those illustrated in the drawing, or a combination of certain components, or a different arrangement of components.

The touch control display screen 303 may be used for displaying a graphical user interface and receiving an operation instruction generated by a user acting on the graphical user interface. The touch control display screen 303 may include a display panel and a touch control panel. In some embodiments, the display panel may be used for displaying information input by the user or information provided to the user, and various graphical user interfaces of the computer device. These graphical user interfaces may include graphics, texts, icons, videos, and any combination thereof. Optionally, the display panel may be configured in the form of a liquid crystal display (LCD), an organic light-emitting diode (OLED), or the like. The touch control panel may be used for collecting the user's touch operation on or near it (e.g., an operation on or near the touch control panel performed by the user using any suitable object or accessory such as a finger and a stylus), and generating a corresponding operation instruction, where the operation instruction executes a corresponding program. Optionally, the touch control panel may include two parts, i.e., a touch detection device and a touch controller. In some embodiments, the touch detection device detects a touch orientation of the user and detects a signal brought about by the touch operation, and transmits the signal to the touch controller. The touch controller receives touch information from the touch detection device and converts it into a contact coordinate, then sends it to the processor 301, and is capable of receiving a command sent by the processor 301 and executes the command. The touch control panel may cover the display panel. When the touch control panel detects a touch operation on or near it, the touch control panel transmits the touch operation to the processor 301 to determine a type of the touch event, and the processor 301 subsequently provides a corresponding visual output on the display panel based on the type of the touch event. In an embodiment of the present disclosure, the input and output functions may be implemented by integrating the touch control panel and the display panel into the touch control display screen 303. However, in some embodiments, the touch control panel and the touch control panel may be used as two independent components to implement the input and output functions. That is, the touch control display screen 303 may also implement the input function as a portion of the input unit 306.

In an embodiment of the present disclosure, the processor 301 executes a game application program to generate the graphical user interface on the touch control display screen 303. The touch control display screen 303 is used for presenting the graphical user interface and receiving the operation instruction generated by the user acting on the graphical user interface.

The RF circuit 304 may be used for receiving and sending an RF signal to establish wireless communications with a network device or other computer devices via a wireless communication, and transceiving of signals is performed between the RF circuit 304 and the network device or other computer devices.

The audio circuit 305 may be used for providing an audio interface between the user and the computer device via a speaker and a microphone. The audio circuit 305 may convert the received audio data into an electrical signal, and transmit the electrical signal to the speaker. The speaker converts the electrical signal into a sound signal for output. On the other hand, the microphone converts the collected sound signal into an electrical signal, and the audio circuit 305 receives the electrical signal and converts the electrical signal into audio data. The audio data is then output to the processor 301 and processed by the processor 301, and then is sent by the RF circuit 304 to, for example, another computer device, or the audio data is output to the memory 302 for further processing. The audio circuit 305 may also include an earbud jack to provide communications between a peripheral headset and the computer device.

The input unit 306 may be used for receiving the input numeric, character information or user characteristic information (e.g., fingerprints, iris, facial information, etc.), and generating keyboard, mouse, action bar, optical or trackball signal inputs related to user settings and function controls.

The power supply 307 is used for providing power to the components of the computer device 300. Optionally, the power supply 307 may be logically connected to the processor 301 via a power supply management system, thereby implementing functions such as management of charging, discharging, and power consumption management via the power supply management system. The power supply 307 may also include any components such as one or more direct current (DC) or alternating current (AC) power sources, a re-charging system, a power supply failure detection circuit, a power supply converter or inverter, a power supply status indicator, etc.

Although not shown in FIG. 10, the computer device 300 may also include a camera, a sensor, a wireless fidelity module, a Bluetooth module, and the like, which will not be repeated here.

In the above embodiments, the description of each embodiment has its own focus, and the portions that are not detailed in a certain embodiment may refer to the relevant descriptions of other embodiments.

As can be seen from the above, this embodiment provides a computer device, where the accessory display page of the virtual weapon is displayed on the graphical user interface in response to the first touch control operation for the virtual weapon in the virtual weapon assembly zone, and the accessory display page is used for displaying a plurality of candidate virtual weapon accessories capable of being assembled onto the virtual weapon; and in response to the second touch control operation for the accessory display page, the target virtual weapon accessory selected by the second touch control operation from the plurality of candidate virtual weapon accessories is determined, and the target virtual weapon accessory is assembled onto the virtual weapon. The player in the embodiments of the present disclosure can perform touch control operations for different virtual weapon assembly regions, thus the accessory display page corresponding to the virtual weapon selected by the user is displayed on the user interface, and virtual weapon accessories capable of being assembled onto the virtual weapon are displayed through the accessory display page, which enables quick completion of accessory equipping and replacement of the virtual weapon, simplifying assembly steps of the virtual weapon accessory of the virtual weapon, improving the efficiency of game interaction, and improving the player's game experience.

Those ordinary skilled in the art can understand that all or some of the steps in the various methods of the above embodiments may be accomplished through instructions, or may be accomplished through instructions controlling the relevant hardware, where the instructions may be stored in a computer-readable storage medium, and loaded and executed by a processor.

To this end, the embodiments of the present disclosure provide a computer-readable storage medium storing a plurality of computer programs. The computer programs are capable of being loaded by a processor to perform the steps in any of the virtual weapon processing methods provided in the embodiments of the present disclosure. For example, the computer programs may perform the following steps:
in response to a first touch control operation for the virtual weapon in the virtual weapon assembly zone, displaying on the graphical user interface an accessory display page of the virtual weapon, where the accessory display page is used for displaying a plurality of candidate virtual weapon accessories capable of being assembled onto the virtual weapon; and
in response to a second touch control operation for the accessory display page, determining a target virtual weapon accessory selected by the second touch control operation from the plurality of candidate virtual weapon accessories, and assembling the target virtual weapon accessory onto the virtual weapon.

In an embodiment, the virtual weapon assembly zone includes a first weapon assembly region and a second weapon assembly region, the first weapon assembly region is used for displaying a first virtual weapon assembled for the first virtual character, and the second weapon assembly region is used for displaying a second virtual weapon assembled for the first virtual character; and
the method includes:
in response to a first switching operation for the first weapon assembly region, controlling the first virtual character to use the first virtual weapon corresponding to the first weapon assembly region; and
in response to a second switching operation for the second weapon assembly region, determining that the first virtual character currently uses a virtual weapon corresponding to the second weapon assembly region, thereby controlling the first virtual character to use the second virtual weapon corresponding to the second weapon assembly region.

In an embodiment, the first touch control operation is an operation satisfying at least one of the following preset conditions:
a contact area between a touch control point of the first touch control operation and the graphical user interface satisfying a preset area threshold;
a pressure value of the first touch control operation satisfying a preset pressure threshold;
the first touch control operation being an operation satisfying a preset touch control duration threshold; and
the first touch control operation being an operation operating on the graphical user interface for a preset number of times within a preset time period.

In an embodiment, the accessory display page includes an accessory selection zone and an accessory use zone, where the accessory selection zone is used for displaying the plurality of candidate virtual weapon accessories capable of being assembled onto the virtual weapon, and the accessory use zone is used for displaying a virtual weapon accessory currently assembled onto the virtual weapon; and
in response to the second touch control operation for the accessory display page, determining the target virtual weapon accessory selected by the second touch control operation from the plurality of virtual weapon accessories, and assembling the target virtual weapon accessory onto the virtual weapon includes:
in response to the second touch control operation for the accessory selection zone, determining the target virtual weapon accessory selected by the second touch control operation from the plurality of candidate virtual weapon accessories, and assembling the target virtual weapon accessory onto the virtual weapon by adding the target virtual weapon accessory to the accessory use zone.

In an embodiment, the method further includes:
in response to a third touch control operation for a virtual weapon accessory to be introduced in the plurality of candidate virtual weapon accessories, displaying an information display zone on the graphical user interface, and displaying in the information display zone accessory information corresponding to the virtual weapon accessory to be introduced, where the third touch control operation is different from the second touch control operation.

In an embodiment, the second touch control operation includes a press operation and a lift operation, where the press operation is an operation in which a touch control medium contacts the graphical user interface, and the lift operation is an operation in which the touch control medium is detached from the graphical user interface;
the step of in response to the second touch control operation for the accessory display page, determining the target virtual weapon accessory selected by the second touch control operation from the plurality of candidate virtual weapon accessories, and assembling the target virtual weapon accessory onto the virtual weapon includes:
receiving the press operation for the accessory display page; and
in response to the lift operation, assembling onto the virtual weapon, a virtual weapon accessory, in the plurality of candidate virtual weapon accessories, corresponding to an operation position of the lift operation.

In an embodiment, the method further includes:
in response to a touch control operation parameter of the press operation satisfying a parameter threshold, displaying an information display zone on the accessory display page displayed on the graphical user interface, and displaying in the information display zone accessory information corresponding to the candidate virtual weapon accessory.

In an embodiment, the accessory display page further includes an information display zone, the information display zone is used for displaying accessory information and a use control corresponding to the candidate virtual weapon accessory, and the use control is used for assembling a virtual weapon accessory onto the virtual weapon;
after displaying on the graphical user interface the accessory display page of the virtual weapon, the method further includes:
in response to a third touch control operation for a candidate virtual weapon accessory on the accessory display page, displaying, in the information display zone, accessory information and a use control corresponding to the candidate virtual weapon accessory.

In an embodiment, in response to the second touch control operation for the accessory display page, determining the target virtual weapon accessory selected by the second touch control operation from the plurality of candidate virtual weapon accessories, and assembling the target virtual weapon accessory onto the virtual weapon includes:
in response to the second touch control operation for a use control in the information display zone on the accessory display page, determining a candidate virtual weapon accessory corresponding to the use control as the target virtual weapon accessory, and assembling the target virtual weapon accessory onto the virtual weapon.

In an embodiment, in response to the first touch control operation for the virtual weapon in the virtual weapon assembly zone, displaying on the graphical user interface the accessory display page of the virtual weapon includes:
in response to the first touch control operation for the virtual weapon in the virtual weapon assembly zone, determining a target display position based on a display position of the virtual weapon assembly zone, where the target display position is a position for displaying the accessory display page of the virtual weapon; and
obtaining a preset page size parameter and accessory information, and generating the accessory display page of the virtual weapon based on the preset page size parameter and the accessory information, where the accessory information is accessory information of a virtual weapon accessory, in a prop backpack, capable of being assembled onto the virtual weapon.

In an embodiment, after in response to the first touch control operation for the virtual weapon in the virtual weapon assembly zone, and before displaying on the graphical user interface the accessory display page of the virtual weapon, the method further includes:
determining whether a virtual weapon is assembled in the virtual weapon assembly zone;
if yes, displaying on the graphical user interface the accessory display page of the virtual weapon; and
if no, displaying a weapon selection page on the graphical user interface, where the weapon selection page is used for displaying a virtual weapon, in a prop backpack, capable of being assembled into the virtual weapon assembly zone.

In an embodiment, displaying the weapon selection page on the graphical user interface includes:
in response to a selection operation for a target virtual weapon on the weapon selection page, assembling the target virtual weapon for the first virtual character, displaying the target virtual weapon in the virtual weapon assembly zone, and generating a page switching instruction for the weapon selection page; and
in response to the page switching instruction for the weapon selection page, canceling the displaying of the weapon selection page on the graphical user interface, and displaying on the graphical user interface the accessory display page of the target virtual weapon.

In an embodiment, after in response to the first touch control operation for the virtual weapon in the virtual weapon assembly zone, and before displaying on the graphical user interface the accessory display page of the virtual weapon, the method further includes:
in response to the first touch control operation for the virtual weapon in the virtual weapon assembly zone, displaying on the graphical user interface a page selection window, where the page selection window is used for displaying a candidate page identification, and the candidate page identification includes an accessory display page identification and/or a weapon selection page identification; and
in response to a terminate operation of the first touch control operation, determining a candidate page identification corresponding to a terminate position of the operation on the page selection window when the operation is terminated as a target page identification, and displaying on the graphical user interface a display page corresponding to the target page identification.

The specific embodiments of the above operations may refer to the foregoing embodiments, and will not be repeated here.

In some embodiments, the storage medium may include a read only memory (ROM), a random access memory (RAM), a magnetic disc, or a compact disc, etc.

Due to the computer program stored in the storage medium, the accessory display page of the virtual weapon can be displayed on the graphical user interface in response to the first touch control operation for the virtual weapon in the virtual weapon assembly zone, where the accessory display page is used for displaying a plurality of candidate virtual weapon accessories capable of being assembled onto the virtual weapon; and in response to the second touch control operation for the accessory display page, the target virtual weapon accessory selected by the second touch control operation from the plurality of candidate virtual weapon accessories is determined, and the target virtual weapon accessory is assembled onto the virtual weapon. The player in the embodiments of the present disclosure can perform touch control operations for different virtual weapon assembly regions, thus the accessory display page corresponding to the virtual weapon selected by the user is displayed on the user interface, and virtual weapon accessories capable of being assembled onto the virtual weapon are displayed through the accessory display page, which enables quick completion of accessory equipping and replacement of the virtual weapon, simplifying assembly steps of the virtual weapon accessory of the virtual weapon, improving the efficiency of game interaction, and improving the player's game experience.

In the above embodiments, the description of each embodiment has its own focus, and the portions that are not detailed in a certain embodiment may refer to the relevant descriptions of other embodiments.

The above provides a detailed introduction to the virtual weapon processing method and apparatus, the computer device, and the storage medium provided in the embodiments of the present disclosure. Specific examples are applied in this article to illustrate the principles and implementations of the present disclosure. The description of the above embodiments is only used to assist in the understanding of the technical solutions of the present disclosure and its core ideas. Those ordinary skilled in the art should understand that they can still modify the technical solutions recorded in the foregoing embodiments, or substitute a portion of the technical features with equivalent ones; and these modifications or substitutions do not take the essence of the corresponding technical solutions out of the scope of the technical solutions of the embodiments of the present disclosure.

1-13. (canceled)

14. An adapter for a sexual stimulation apparatus, comprising:
a first body and a second body configured to hold an adult toy;
a connector disposed on the first body or the second body, wherein the connector is configured to detachably connect to a sliding component of the sexual stimulation apparatus;
a spring disposed between the first body and the second body; and
a quick release member configured to pass through the first body and the second body,
wherein the spring is in a compressed state when the first body and second body are fixed together by the quick release member, and
wherein the adapter is configured to connect to the sexual stimulation apparatus via the connector, and the adapter is configured to reciprocate following the sliding component of the sexual stimulation apparatus, such that the adult toy held by the first body and the second body is driven to perform reciprocating motion along with the adapter.

15-20. (canceled)

21. The adapter according to claim 14, wherein an elastic force of the spring automatically separates the first body from the second body when the quick release member is released.

22. The adapter according to claim 14, wherein the first body and the second body are configured to clamp an adult toy of any shape or structure.

23. The adapter according to claim 14, wherein the adapter is further configured to serve as an extension rod to extend a length of a pushing rod of the sliding component.

24. The adapter according to claim 14, wherein the first body and the second body are configured to clamp a plurality of adult toys at the same time.

25. The adapter according to claim 14, wherein the first body and the second body are formed as a clip structure or a ring structure.

26. The adapter according to claim 14, wherein the connector is configured to be detachably connected to a pushing rod of the sliding component.

27. The adapter according to claim 14, wherein the first body and the second body firmly clamp the adult toy when the spring is in the compressed state.

28. The adapter according to claim 14, wherein the adapter is configured to clamp the adult toy or an extension rod connected to the adult toy.

29. A sexual stimulation apparatus, comprising the adapter according to claim 14, wherein the sexual stimulation apparatus further comprises:
a tube; and
a first coil disposed on the tube,
wherein the sliding component is slidably disposed in the tube, the sliding component comprises at least one end extending out of the tube,
wherein the sliding component comprises a magnetic structure configured to drive the sliding component to perform linear reciprocating motion according to a first driving force provided by the first coil.

30. The sexual stimulation apparatus according to claim 29, wherein the sliding component comprises a pushing rod having at least one end extending out of the tube, and wherein the magnetic structure is sleeved on the pushing rod.

31. The sexual stimulation apparatus according to claim 30, wherein the sliding component further comprises a restoring structure sleeved on the pushing rod, wherein the restoring structure is propped against the tube and configured to restore a linear movement of the pushing rod.

32. The sexual stimulation apparatus according to claim 31, wherein the restoring structure comprises a spring sleeved on and connected to the pushing rod, and wherein the spring is accommodated in the tube and propped against an end of the tube.

33. The sexual stimulation apparatus according to claim 31, wherein the restoring structure comprises a first stopper, a second stopper and a spring disposed between the first stopper and the second stopper, and wherein the first stopper is propped against an end of the tube.

34. The sexual stimulation apparatus according to claim 29, further comprising a second coil disposed at a side of the first coil in the longitudinal direction of the tube, wherein the second coil is configured to provide a second driving force to the sliding component, and the second driving force is opposite in direction to the first driving force.

35. The sexual stimulation apparatus according to claim 29, further comprising a third coil disposed to be spaced apart from the first coil by a predetermined distance in the longitudinal direction of the tube, wherein the third coil is configured to apply a repulsive force to stop the sliding component.

36. The sexual stimulation apparatus according to claim 29, further comprising an isolator configured to isolate the first coil from other coils.

37. The sexual stimulation apparatus according to claim 29, further comprising a guide coaxially disposed at an end of the tube, wherein the guide is configured to guide the linear reciprocating motion of the sliding component in the longitudinal direction of the tube.

38. The sexual stimulation apparatus according to claim 29, further comprising a housing having a cavity configured to accommodate the tube, wherein the tube is fixed to the housing by a pair of fixers disposed at both ends of the tube, and wherein the housing comprises a first via hole through which the sliding component is extended and a second via hole through which a heat dissipating device is disposed.

39. The sexual stimulation apparatus according to claim 38, wherein each of the fixers comprises a first body and a second body opposite to the first body, and an assembly of the first body and the second body is clamped on an outer surface of the tube.
